(19) United States
(12) Patent Application Publication
(10) Pub. No.: US 2015/0233265 A1
(43) Pub. Date: Aug. 20, 2015

(54) INTEGRATED COOLING SYSTEM FOR A NACELLE OF A WIND TURBINE

(71) Applicant: YOUWINENERGY GMBH, Oldenburg (DE)

(72) Inventor: Rolf Rohden, Aurich (DE)

(73) Assignee: YOUWINENERGY GMBH, Oldenburg (DE)

(21) Appl. No.: 14/420,726

(22) PCT Filed: Aug. 9, 2013
(86) PCT No.: PCT/EP2013/066758

§ 371 Date: Feb. 10, 2015

(30) Foreign Application Priority Data
Aug. 10, 2012 (EP) 12180030.4

(51) Int. Cl. F01D 25/12; F03D 9/00; F03D 11/00

(52) U.S. Cl. CPC F01D 25/12; F03D 11/0058; F03D 11/0075; F03D 9/002

(57) ABSTRACT

The cooling system comprises a nacelle body, a heat exchanger mounted on an outer surface of the nacelle body, a generator having a stator with holes disposed close to the windings, a rectifier having liquid circulating heat sink, a rotor and a hub having a plurality of fins, a pump, one or more fans, and a plurality of pipes for carrying a coolant therethrough.

### BACKGROUND OF THE INVENTION

This invention relates to a cooling system of a wind turbine, and particularly to a cooling system integrated within the nacelle of the wind turbine.

In wind turbines, a nacelle houses electrical components and systems that convert mechanical energy into electricity. The components may range from generators, fans, brakes, converters including inverter, transformers, and electronic components. These systems and components generate a significant amount of heat. In an example, energy may be lost due to electrical losses in the generator during conversion of kinetic energy from wind into the electric energy. In another example, energy may be lost in electronic devices, such as an inverter or rectifier of the wind turbine. Such losses of energy may cause generation of heat within the nacelle of the wind turbine. This heat needs to be dissipated to outside ambient air for efficient operation of the systems and components housed inside the nacelle.

Conventionally, the nacelle is cooled by introducing external air to the nacelle. However, introduction of the external air may result in corrosion of the various components housed within the nacelle as the external air is humid and may include high salt particle content. It may also cause physical damage due to mechanical particles contained in the air. Accordingly, interior portions of the wind turbine, such as nacelle, are at risk due to foreign bodies or corrosive substances that attack or interfere with the working of electrical systems and components. This leads to inefficiency, reduced life of systems and components, and an increase in frequency of maintenance downtime and cost.

Additionally, in absence of power available to cool the nacelle, e.g. during grid loss or times of no wind, the systems and components within the nacelle may not get cooled up properly which may affect the working of the wind turbine. Further, the cooling done by means of the external air may not be sufficient to maintain a pre-determined temperature within the nacelle.

### SUMMARY OF THE INVENTION

The invention relates to a cooling system and more particularly to a cooling system completely enclosed within the nacelle. The nacelle is substantially sealed to prevent outside air from entering the nacelle. The cooling system includes one or more cooling sub-systems that may facilitate in maintaining a pre-determined temperature within the nacelle.

The cooling system further comprises a nacelle body, a heat exchanger mounted on an outer surface of the nacelle body, a generator having a stator with holes disposed close to the windings, a rectifier having liquid circulating heat sink, a rotor and a hub having a plurality of fins, a pump, one or more fans, and a plurality of pipes for carrying a coolant therethrough.

Further, a first cooling sub-system may include a stator of a generator, the pump, and the heat exchanger. The stator is provided with a plurality of holes through which the coolant may be circulated. Alternatively, the stator may be provided with a plurality of tubes or ducts that may be configured to carry the coolant. The coolant may absorb the heat generated by the stator. Further, the heat may be dissipated by pumping the hot coolant through the heat exchanger placed on an outer surface of the nacelle.

Further, a second cooling sub-system may include a rectifier, the pump, and the heat exchanger. The coolant, in this case, is circulated through a heat sink placed on the rectifier. Upon absorbing the heat from the rectifier, the hot coolant may be pumped to the heat exchanger for cooling. As is the case in the first cooling sub-system, once the coolant is cooled, it may be re-circulated in the nacelle for heat absorption.

Additionally, a third cooling sub-system may include one or more fans for circulating air directed to other parts, such as rotor, pitch system, and other electrical components, within the nacelle. The air may get heated up due to the heat generated within the nacelle. This hot air is directed to flow over the inside surface of the nacelle so as to dissipate the heat from the outside body of the nacelle and hub. The air is further cooled by the coolant that is circulated by the first and the second cooling sub-systems. As mentioned above, the generator rotor and the hub of the wind turbine is provided with a plurality of fins that may facilitate in efficient dissipation of the heat.

The present subject matter also provides a control unit for monitoring the temperature inside the nacelle. The control unit may activate a fourth cooling sub-system in case high temperature is monitored inside the nacelle. The fourth cooling sub-system is configured to maintain the temperature in the nacelle within a pre-determined limit.

Also, the present subject matter provides a heat exchanger arrangement of a nacelle for a wind turbine, said nacelle being adapted to carry a horizontal axis wind turbine rotor, with a heat exchanger comprising walls, coolant passages extending between the walls and a cover connecting the walls, the walls and the cover forming a longitudinally extending flow passage, wherein the heat exchanger is arranged on said nacelle so that the flow passage is skewed with respect to the axis of the horizontal axis rotor.

The flow passage may be skewed with respect to the axis of the horizontal axis wind turbine rotor so that the flow passage is oriented towards air approaching the heat exchanger.

The walls may be skewed with respect to the axis of the horizontal axis wind turbine rotor at an angle between 10° and 30°, preferably between 12° and 20°.

The present subject matter also provides a wind turbine comprising a nacelle enclosing a generator, a hub connected to said generator, a rectifier, and an integrated cooling system described above. In the latter wind turbine, the heat exchanger of the integrated cooling system may be arranged according to the heat exchanger arrangement described above.

That is, the present subject matter provides a nacelle cooling system wherein the nacelle is substantially sealed so as to prevent air entering from outside, and wherein the air is circulated within the nacelle for cooling purpose. This facilitates in protecting the electrical and mechanical components of the nacelle from the particles contained in the air or its humidity which may cause corrosion of the electrical or mechanical components. The cooling system may further be configured to provide liquid and air based cooling of the generator and/or rectifier and other electrical equipment in the nacelle of the wind turbine for providing efficient cooling within the nacelle. Additionally, the present subject matter provides a control unit that monitors the temperature within the nacelle. If the temperature exceeds a pre-determined limit, the control unit may start an active cooling system that is designed to maintain the temperature of the nacelle within the pre-determined limit. Accordingly, the present subject matter maintains the pre-determined temperature within the nacelle for ensuring normal functioning of the wind turbine.

The invention is to cover at least the following concepts which can be combined in any possible manner and which can be supplemented by any information set out in the present document including the text and the drawings:

The invention relates to a cooling system and more particularly to a cooling system completely enclosed within the nacelle.

The nacelle is substantially sealed to prevent outside air from entering the nacelle.

The cooling system includes one or more cooling sub-systems that may facilitate in maintaining a pre-determined temperature within the nacelle.

The cooling system further comprises a nacelle body, a heat exchanger mounted on an outer surface of the nacelle body, a generator having a stator with holes disposed close to the windings, a rectifier having liquid circulating heat sink, a rotor and a hub having a plurality of fins, a pump, one or more fans, and a plurality of pipes for carrying a coolant therethrough.

Further, a first cooling sub-system may include a stator of a generator, the pump, and the heat exchanger.

The stator is provided with a plurality of holes through which the coolant may be circulated.

Alternatively, the stator may be provided with a plurality of tubes or ducts that may be configured to carry the coolant.

The coolant may absorb the heat generated by the stator. Further, the heat may be dissipated by pumping the hot coolant through the heat exchanger placed on an outer surface of the nacelle.

Further, a second cooling sub-system may include a rectifier, the pump, and the heat exchanger.

The coolant, in this case, is circulated through a heat sink placed on the rectifier. Upon absorbing the heat from the rectifier, the hot coolant may be pumped to the heat exchanger for cooling.

As is the case in the first cooling sub-system, once the coolant is cooled, it may be re-circulated in the nacelle for heat absorption.

Additionally, a third cooling sub-system may include one or more fans for circulating air directed to other parts, such as rotor, pitch system, and other electrical components, within the nacelle.

The air may get heated up due to the heat generated within the nacelle.

This hot air is directed to flow over the inside surface of the nacelle so as to dissipate the heat from the outside body of the nacelle and hub.

The air is further cooled by the coolant that is circulated by the first and the second cooling sub-systems.

As mentioned above, the generator rotor and the hub of the wind turbine is provided with a plurality of fins that may facilitate in efficiently dissipation of the heat.

The present subject matter also provides a control unit for monitoring the temperature inside the nacelle.

The control unit may activate a fourth cooling sub-system of in case high temperature is monitored inside the nacelle.

The fourth cooling sub-system is configured to maintain the temperature in the nacelle within a pre-determined limit.

The heat exchanger is arranged in such a manner that the flow direction of air entering the flow passage remains substantially unchanged leading to a smooth entry of air into the flow passage. Accordingly, an optimum flow is achieved by reducing flow losses enhancing the overall efficiency of the heat exchanger.

### BRIEF DESCRIPTION OF THE DRAWINGS

FIG. 1 is a 3D model of a wind turbine with a hub and a heat exchanger;

FIG. 2 is a 3D model showing a rear side of the heat exchanger as per our invention;

FIG. 3 is a 3D model showing a wind turbine with the heat exchanger as per our invention;

FIG. 4 is a 3D model showing the wind turbine with fins as per our invention;

FIG. 5 is a 3D model showing the heat exchanger with fins as per our invention; and

FIG. 6 is a block diagram of the first and the second cooling sub-system as per our invention.

### EMBODIMENT

The invention relates to a cooling system and more particularly to a cooling system completely enclosed within a nacelle 102. The nacelle 102 in turn is substantially sealed to prevent outside air from entering the nacelle 102.

The cooling system comprises a nacelle body 104, a heat exchanger 128 mounted on an outer surface of the nacelle body 104, a generator 120 having a stator 122 with holes which are disposed close to the windings, a rectifier 124 having a liquid cooled heat sink, a rotor 108 and a hub 106 having a plurality of fins 110, a pump 126, one or more fans, and a plurality of pipes 129 for carrying a coolant therethrough. The components of cooling system are grouped in one or more cooling sub-systems that may facilitate in maintaining a pre-determined temperature within the nacelle 102.

A first cooling sub-system is a closed circuit cooling system. The first cooling sub-system may include the stator 122 of a generator 120, the pump 126, and the heat exchanger 128. As mentioned above, the stator 122 is provided with a plurality of holes that may be close to the windings of the stator 122. Alternatively, the stator 122 may be provided with a plurality of tubes or ducts that may be configured to carry the coolant. Further, the coolant, such as water, may enter the plurality of holes from one end of the stator 122 and may get heated up by absorbing the heat generated near the windings. The heated coolant may then be taken away from an opposite end of the stator 122. Alternatively, the plurality of holes may be looped in pairs such that the coolant enters one end of the stator 122 and the heat bearing coolant returns from the same side of the stator 122 through the neighbouring holes. The heated coolant may then be pumped to the heat exchanger 128 for discharging the heat.

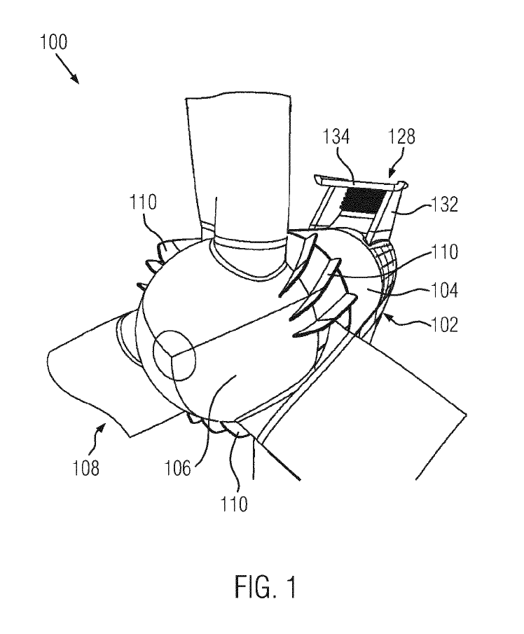

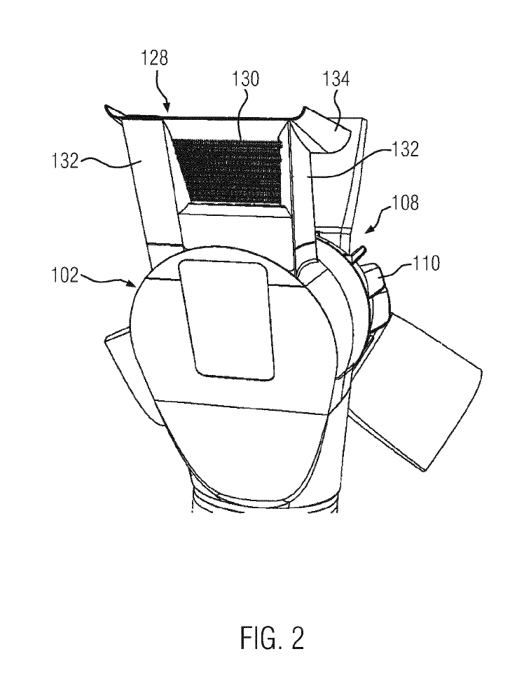

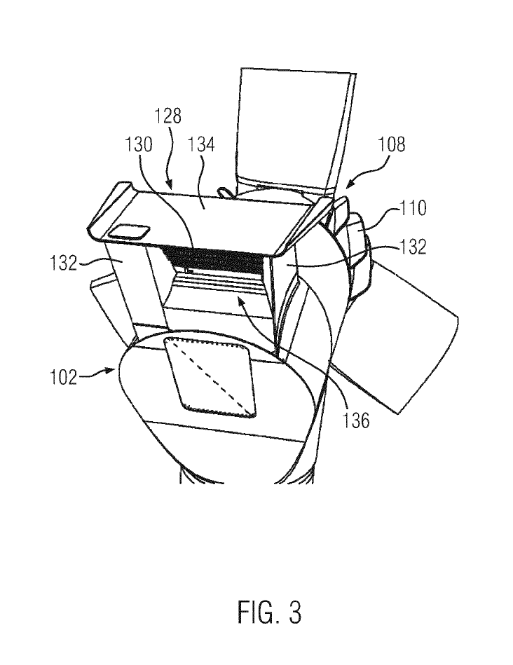

Further, as depicted in FIGS. 1 through 5, the heat exchanger 128 may include a plurality of coolant passages 130 through which the heated coolant may flow. Additionally, each of the plurality of coolant passages 130 may also include a plurality of fins. This may facilitate in cooling the heated coolant in an efficient manner, which may then be re-circulated into the stator through the plurality of holes.

As is shown in FIGS. 1 through 5, the rotor 108 is a horizontal axis wind turbine rotor and the heat exchanger 128 comprises two elongate walls 132 protruding from the outer surface of the nacelle 102, a cover 134 mounted on the two walls 132 and connecting the ends of the walls 132, wherein the surface of the nacelle 102, the walls 132 and the cover 134 form the flow passage 136 of the heat exchanger 128, and the coolant passages 130 cross the flow passage 136.

The cooling of components within the nacelle is affected through the wind flows on the heat exchanger 108. However, due to the spinning of the rotor blades, the direction of the wind flow in the wake region of the rotor blades gets skewed. As a result, the incoming wind flow direction may not get incident, fully and effectively, onto the heat exchanger 108. To this end, in one embodiment, the heat exchanger 108 may be skewed. For example, the plane of the heat exchanger 108 extending from the fore portion to the aft portion of the heat exchanger 108 does not coincide with a vertically extending plane incident along the rotational axis of the wind turbine. In other words, the walls 132 may each be inclined at a predetermined angle to the vertically extending plane. As a result of the skewness, the incoming wind flows are effectively incident on the heat exchanger 108 thereby increasing the efficiency of the cooling system for the wind turbine. In one implementation, the walls 132 may be skewed at an angle between 10° and 30°, and preferably between 12° and 20°.

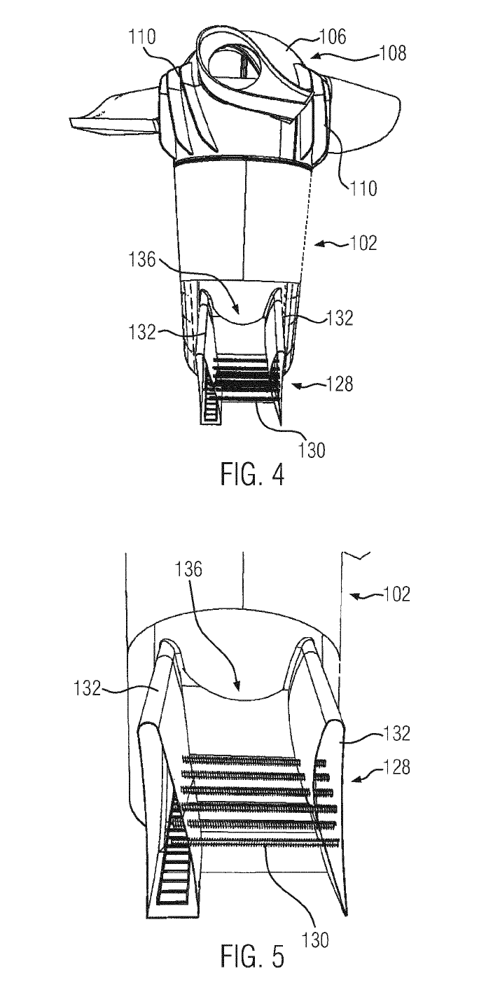

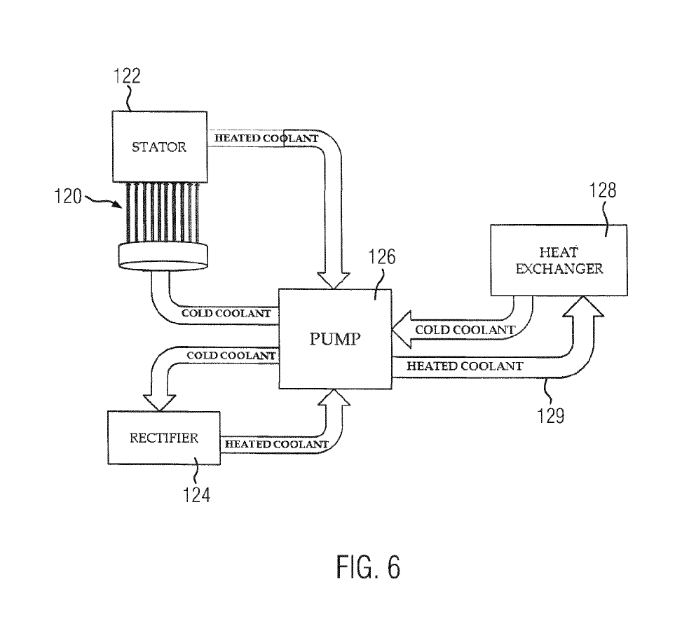

This arrangement is best shown in FIGS. 4 and 5. As shown in the latter figures, the walls 132 are formed aerodynamically at least on the inner sides facing the passage and have a rounded nose portion facing the approaching air flow. Furthermore, the walls are optionally constructed an that the flow passage 136 comprises a portion in which its cross-sectional area is narrowed. Preferably, the flow passage 136 has a nozzle-like shape.

The coolant passages 130 extend between the walls 134. The coolant passages 130 are offset in the radial direction with respect to the rotational axis of the rotor 108 and preferably in parallel to each other and in a plane perpendicular to the rotational axis of the rotor 108. In one implementation, the coolant passage can be made of copper tubes.

With the above arrangement, the flow passage 136 is oriented towards the approaching air. Therefore, the flow direction of the air approaching the heat exchanger 128 directly in front of an inlet of the heat exchanger 128 substantially corresponds to the flow direction of air within the flow passage 136 near the inlet. In this connection, flow direction is to be understood as the average flow direction faced by the cross-sectional area of the flow passage 136. In other words, the flow direction is the average flow direction throughout the cross-sectional area of the flow passage 136. Accordingly, the flow direction of air entering the flow passage 136 remains substantially unchanged leading to a smooth entry of air into the flow passage 136. Consequently, an optimum flow is achieved by reducing flow losses enhancing the overall efficiency of the heat exchanger 128.

In another implementation, the cooling system may include a second cooling sub-system that is also a close circuit cooling system. The second cooling sub-system may include a liquid cooled heat sink mounted on the rectifier 124, the pump 126, and the heat exchanger 128. The second cooling sub-system may be configured to circulate the coolant around the rectifier 124 through the heat sink. In the present implementation, the coolant may be circulated through the rectifier by means of a plurality of channels inside the heat sink that may be configured to carry the coolant. The coolant may absorb the heat generated from the rectifier 124, and the heated coolant may be pumped to the heat exchanger 128 for cooling thereof. Once cooled, the coolant may be re-circulated in the rectifier 124 through the plurality of channels for heat absorption.

It will be evident to a person skilled in the art that the first and the second cooling sub-systems may include more than one pump 126 for pumping the coolant to the rectifier 124 or stator 122 and the heat exchanger 128.

In yet another implementation, the cooling system may include a third cooling sub-system which is also a closed circuit stator cooling system. The third cooling sub-system may include one or more fans for circulating the air within the nacelle 102. In the present subject matter, the third cooling sub-system works in conjunction with the first and the second cooling sub-systems. Therefore, when the air circulated by the one or more fans gets heated up due to the heat generated within the nacelle 102, the coolant may be circulated by means of the first and the second cooling sub-systems for cooling the air inside the nacelle 102. Moreover, as mentioned above, the rotor 108 and the hub 106 of the wind turbine 100 are provided with the plurality of fins 110 that may facilitate in heat dissipation. Accordingly, the hot air may also dissipate the heat through the plurality of fins 110. The first, second, and the third cooling sub-systems may work independently or in combination with each other.

Additionally, the present subject matter provides a control unit that may monitor the temperature inside the nacelle 102. If the control unit identifies that the temperature within the nacelle 102 exceeds a predetermined limit, the control unit may start a fourth cooling sub-system. The fourth cooling sub-system is an active cooling sub-system that may include a cooling unit and a heat exchanger 128. This cooling sub-system may be configured to maintain the temperature in the nacelle 102 within the predetermined limit.

At least the following effects and advantages are achievable with the invention:

The cooling system is enclosed within the nacelle 102, which in turn is substantially sealed so that no outside air can come inside the nacelle 102. This protects the electrical components of the nacelle 102 from corrosion and dust.

The substantially sealed nacelle 102 requires lesser maintenance for the reasons mentioned above.

The cooling system of the present subject matter facilitates in maintaining a predetermined temperature within the nacelle 102 by using the one or more cooling sub-systems alone or together.

Re-circulation of the coolant reduces cost of the overall system.

1. An integrated cooling system of a wind turbine (100) including a generator (120) having a stator (122) and at least one rectifier (124), the integrated cooling system comprising:
at least one pump (126) for pumping coolant;
at least one heat exchanger (128);
a first cooling subsystem for controlling the cooling of said stator (122) by,
pumping said coolant through said stator (122) by said at least one pump (126), and
rejecting heat extracted from said stator (122) through said at least one heat exchanger (128); and
a second cooling subsystem for controlling the cooling of said at least one rectifier (124) by,
pumping said coolant through said rectifier (124) by said at least one pump (126), and
rejecting heat extracted from said stator (122) through said at least one heat exchanger (128).

2. The integrated cooling system according to claim 1, further comprising a nacelle (102) of said wind turbine (100), said integrated cooling system being enclosed in said nacelle (102).

3. The integrated cooling system according to claim 2, wherein said nacelle (102) is substantially sealed to prevent outside air from entering said nacelle (102).

4. The integrated cooling system according to claim 1, wherein said stator (122) is provided with a plurality of holes, disposed close to windings of said stator (122), through which said coolant is circulated.

5. The integrated cooling system according to claim 2, wherein said stator (122) is provided with a plurality of tubes or ducts that are configured to carry said coolant.

6. The integrated cooling system according to claim 1, wherein said rectifier (124) includes a heat sink and wherein said coolant is circulated through said heat sink.

7. The integrated cooling system according to claim 2, wherein said heat exchanger (128) placed on an outer surface of said nacelle (112).

8. The integrated cooling system according to claim 2, wherein said coolant, after being cooled by said heat exchanger (128), is recirculated in said nacelle (102) for heat absorption.

9. The integrated cooling system according to claim 1, further comprising a third cooling subsystem including one or more fans for circulating air within said wind turbine (100).

10. The integrated cooling system according to claim 9, wherein said one or more fans are directed towards parts within said nacelle (102) within said wind turbine.

11. The integrated cooling system according to claim 2, wherein air inside said nacelle (102), heated due to the heat generated within said nacelle (102), is directed to flow over an inside surface of said nacelle (102) so as to dissipate the heat from the outside body of said nacelle (102) and a hub (106) of said wind turbine (100).

12. The integrated cooling system according to claim 1, wherein a rotor (108) of said wind turbine is provided with a plurality of fins (110) that facilitate dissipation of the heat.

13. The integrated cooling system according to claim 2, further comprising a control unit for monitoring and controlling temperature inside said nacelle (102), said control unit being configured to activate a fourth cooling subsystem when temperature inside said nacelle (102) exceeds a predetermined limit.

14. The integrated cooling system according to claim 13, wherein said fourth cooling subsystem is an active cooling system including a cooling unit and is configured to maintain temperature in said nacelle (102) within a predetermined limit temperature range.

15. The integrated cooling system according to claim 1, wherein said coolant is a liquid coolant and said cooling system is a closed-circuit system.

16. Heat exchanger arrangement of a nacelle (102) for a wind turbine (100), said nacelle (102) being adapted to carry a horizontal axis wind turbine rotor (108), comprising
a heat exchanger (128) further comprising a plurality of walls (132);
coolant passages (130) extending between the walls (132); and
a cover (134) connecting the walls (132), said walls (132) and said cover (134) forming a longitudinally extending flow passage (136), wherein said heat exchanger (128) is arranged on said nacelle (102) so that said flow passage (136) is skewed with respect to said axis of the horizontal axis wind turbine rotor (108).

17. The heat exchanger arrangement according to claim 16, wherein said flow passage (136) is skewed with respect to said axis of the horizontal axis rotor (108) so that said flow passage (136) is oriented towards air approaching the heat exchanger (128).

18. The heat exchanger arrangement according to claim 16, wherein said walls (132) are skewed with respect to said axis of the horizontal axis wind turbine rotor (108) at an angle between 10° and 30°, preferably between 12° and 20°.

19. A wind turbine (100) comprising a nacelle (102) enclosing a generator (120), a hub (106) connected to said generator (120), a rectifier (124), and an integrated cooling system according to claim 1.

20. The wind turbine (100) according to claim 19, wherein the integrated cooling system comprises a heat exchanger comprising
a plurality of walls (132);
coolant passages (130) extending between the walls (132); and
a cover (134) connecting the walls (132), said walls (132) and said cover (134) forming a longitudinally extending flow passage (136).
